(19) United States
(12) Patent Application Publication
(10) Pub. No.: US 2021/0386514 A1
(43) Pub. Date: Dec. 16, 2021

(54) Device and Method for Making Space Between Teeth

(71) Applicants: Naoko Miki, Tokyo (JP); Hidetoshi Nishio, Chiba (JP)

(72) Inventor: Naoko Miki, Tokyo (JP)

(21) Appl. No.: 17/282,801

(22) PCT Filed: Sep. 27, 2019
(86) PCT No.: PCT/JP2019/038109

§ 371 Date: Apr. 5, 2021

(30) Foreign Application Priority Data
Oct. 5, 2018 (JP) 2018-190498

(51) Int. Cl. A61C 3/03; A61C 1/07; A61C 3/06; A61C 1/00

(52) U.S. Cl. CPC A61C 3/03; A61C 1/0061; A61C 3/06; A61C 1/07

(57) ABSTRACT

A device and a method for making space between teeth that can efficiently form a necessary space between adjacent teeth in a short time and reduce the physical burden on both the patient and the person who gives treatment. The device for making space includes an ultrasonic oscillator, an ultrasonic vibrator which receives a driving signal from the ultrasonic oscillator and vibrates ultrasonically, a grinding tip to which the vibration from the ultrasonic vibrator is transmitted, and a power supply device which supplies power to the ultrasonic oscillator. The opposing surfaces of the adjacent teeth T are ground by ultrasonic vibration of the grinding tip inserted between the two adjacent teeth T.

### TECHNICAL FIELD

The present invention relates to a device and a method for making space between teeth to form a necessary space (gap) between adjacent teeth by inserting a grinding tip with files, etc. between the teeth and vibrating it.

### BACKGROUND ART

In dental treatment, for example, tartar and plaque, etc. on the surfaces of teeth are removed and decayed teeth are shaved. The ultrasonic vibration is used to perform these treatments efficiently in a short time. In other words, the tip attached to the tip of the handpiece which the person who gives treatment holds in his/her hand, is made to vibrate ultrasonically, and the ultrasonic vibration of the tip can remove tartar, etc. adhering to the surface of teeth (dentition). There have been various proposals for such treatment devices and methods using ultrasonic vibration.

For example, Patent Document 1 proposes a dental ultrasonic vibration treatment device that automatically sets a drive resonance frequency given to the tip on the handpiece according to the type of the tip, and drives the tip with the optimum power (recommended power) according to the type of the tip to prevent problems such as tip breakage during treatment.

In addition, Patent Document 2 proposes a method of grinding teeth efficiently without increasing the burden on the patient in treatment and the person who gives treatment, in which ultrasonic vibrations are not applied to the teeth, but only to the cutting tool which rotates at high speed by a micromotor.

### RELATED ART DOCUMENTS

### Patent Documents

[Patent Document 1]

Japanese Patent Application Publication No. 2010-042123

[Patent Document 2]

Japanese Patent Application Publication No. 2012-196257

### DISCLOSURE OF THE INVENTION

### Problem to be Solved by the Invention

By the way, for example, in orthodontic treatment to correct the alignment of teeth, a space-making technique called IPR (Interproximal Enamel Reduction) is used to form a suitable space (gap) between two adjacent teeth. Conventionally, this space-making technique is performed by the person who gives treatment moving the file on the grinding tip by hand or by attaching the file to the handpiece and moving it in small increments. Therefore, it takes a huge amount of time (e.g., about 150 to 300 minutes) to form a necessary space between teeth, which is physically demanding both for the patient and the person who gives treatment.

The present invention has been made in view of the above-described problems. Accordingly, an object to the present invention is to provide a device and a method for making space between teeth that can efficiently form a necessary space between adjacent teeth in a short time, and reduce the physical burden on the patient and the person who gives treatment.

### Means of Solving the Problems

The present invention for achieving the above object is a device for making space between teeth for forming a necessary space (δ) between teeth (T), including at least, an ultrasonic oscillator (6), an ultrasonic vibrator (7), a grinding tip (3), and a power supply device (4). The ultrasonic vibrator (7) received a driving signal from the ultrasonic oscillator (6), and vibrates ultrasonically. The vibration of the ultrasonic vibrator (7) is transmitted to the grinding tip (7). The power supply device (4) supplies power to the ultrasonic oscillator (6).

In the device for making space between teeth according to the present invention, the grinding tip is inserted between the two adjacent teeth to grind the opposing surfaces of the two teeth by ultrasonic vibration of the grinding tip. As a result, a necessary space between the two teeth can be formed efficiently in a short time and the physical burden on both the patient and the person who gives treatment can be reduced.

In the device for making space between teeth, the grinding tip (3) may include a file (3b) consisting of hard particles adhered to the surface of a flat substrate.

The device for making space between teeth may include a handpiece (2) with a built-in holder (8) connected to the ultrasonic vibrator (7), and the grinding tip (3) is detachably attached to the holder (8), and a water pouring section (5) is installed inside or outside of the handpiece (2) to supply water toward the grinding tip (3).

A method for making space between teeth according to the present invention is a method to form a necessary space (δ) between teeth (T) using a device for making space (1) that includes at least, an ultrasonic oscillator (6), an ultrasonic vibrator (7), a grinding tip and a power supply device (4). The ultrasonic vibrator (7) receives a driving signal from the ultrasonic oscillator (6), and vibrates ultrasonically. The vibration of the ultrasonic vibrator (7) is transmitted to the grinding tip (7). The power supply device (4) supplies power to the ultrasonic oscillator (6). The grinding tip (3) is inserted between the two adjacent teeth (T), and is used to grind the opposing surfaces of the two teeth (T) by its ultrasonic vibration.

In the method for making space between teeth according to the present invention, the grinding tip is inserted between two adjacent teeth, and ultrasonic vibrations are applied to the grinding tip to grind the opposing surfaces of the two teeth. As a result, a necessary space between the two teeth can be formed efficiently in a short time and the physical burden on both the patient and the person who gives treatment can be reduced.

In the method for making space between teeth according to the present invention, the device for space making (1) includes a handpiece (2) with a built-in holder (8) connected to the ultrasonic vibrator (7), and a plurality of the grinding tip (3) with different thickness are prepared. Then, the process of sequentially replacing the thinner grinding tip (3) with the thicker grinding tips (3) on the holder (8) of the handpiece (2) and grinding the opposing surfaces of the adjacent teeth (T) by the grinding tip is repeated multiple times.

According to the method, by repeating the process of sequentially replacing the thinner grinding tip with the thicker ones on the holder of the handpiece, and grinding the opposing surfaces of the adjacent teeth by the grinding tip multiple times, a space between the two adjacent teeth gradually increases. Finally, a space of the desired size can be formed.

In the method for making space between teeth according to the present invention, the teeth (T) may be ground while water is supplied to the grinding area of the teeth (T) by the grinding tip (3).

In the method, water is continuously supplied from the water pouring hose to the grinding area of the teeth by the file at the same time as the teeth are ground. This water promotes the discharge of grinding dust and the cooling and lubrication of the grinding area.

### Effects of the Invention

With the device and the method for making space between teeth according to the embodiment of the present invention, a necessary space between adjacent teeth can be formed efficiently in a short time and the physical burden on both the patient and the person who gives treatment can be reduced.

### BRIEF DESCRIPTION OF DRAWINGS

FIG. 1 is a general arrangement of the device for making space according to an embodiment of the present invention;

FIG. 2 is a cross-sectional view in the direction of the line A-A in FIG. 1;

FIG. 3 is a partial perspective view illustrating the device for making space being used for space making in the lower interdental;

FIG. 4 is a partial perspective view illustrating the device for making space being used for space making in the upper interdental; and

FIG. 5A is a partial front view illustrating the dentition before space making and 5B is a partial front view illustrating the dentition after space making.

### MODE FOR CARRYING OUT THE INVENTION

An embodiment of the present invention will now be described with reference to the accompanying drawings.

Device for Making Space

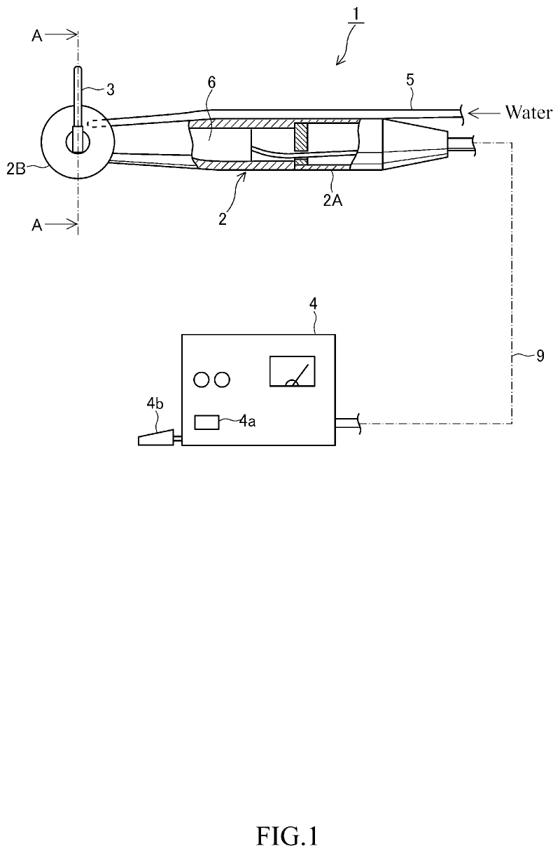

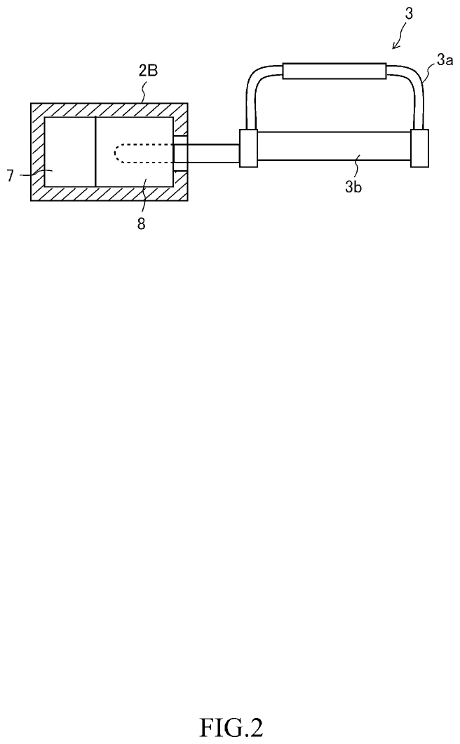

Firstly, a general arrangement of the device for making space between teeth according to the present invention will be described with reference to the FIG. 1 and FIG. 2.

FIG. 1 is a general arrangement of the device for making space according to the present invention, and FIG. 2 is a cross-sectional view in the direction of the line A-A in FIG. 1. The device for making space 1 shown in the FIGs. is a device for forming a space (gap) necessary for orthodontics between two adjacent teeth of a patient in dental treatment. The device for making space 1 includes handpiece 2, a grinding tip 3 detachably attached on the tip of the handpiece 2, a power supply device 4 which supplies power to the handpiece 2, and a water pouring hose (water pouring section) 5 for supplying water toward the grinding area of the teeth by the grinding tip 3 during treatment.

The handpiece 2 includes an approximately cylindrical grasping section 2A, an approximately cylindrical tip section 2B that bends at an approximately right angle from the tip of the grasping portion 2A. As shown in the FIG. 1, an ultrasonic oscillator 6 is accommodated inside the the grasping section 2A. In addition, as shown in the FIG. 2, an ultrasonic vibrator 7 which vibrates ultrasonically by receiving a driving signal from the ultrasonic oscillator 6 and a holder 8 connected the ultrasonic vibrator 7 are accommodated inside the tip section 2B.

Here, the ultrasonic oscillator 6 includes, for example, an unshown transistor, capacitor and a choke coil etc. that are mounted on an unshown circuit board. The ultrasonic vibrator 7 includes, for example, a piezoelectric element and a magnetostrictive element and the like.

As shown in the FIG. 2, the grinding tip 3 includes an U-shaped bent support section (handle) 3a, and a file 3b as a grinding tool whose both ends are supported by the support section 3a. The file 3b is composed of hard fine particles (adrasive grains) such as alumina and diamond adhered to both sides of an elongated and thin rectangular flat substrate made of stainless steel (SUS), for example. The grinding tip 3 composed as mentioned above is detachably attached to the holder 8 (see FIG. 2) built into the handpiece 2 when in use.

The water pouring hose 5 is a thin and flexible tube. In this embodiment, as shown in the FIG. 1, part of the hose is attached along the outer periphery of the handpiece 2. The one end of the hose is connected to an unshown water tap, for example, and the other end opens toward the grinding tip 3, as shown in the FIG. 1. The water pouring hose 5 in this embodiment is provided outside the handpiece 2, but part of the water pouring hose 5 may be provided inside the handpiece 2.

The power supply device 4, for example, converts power from a commercial power supply (AC 100, 50/60 Hz) to a safe voltage of about DC 12V, and rectifies it to supply to the ultrasonic oscillator 6 in the handpiece 2 by means of a power supply cord 9. Also, the power supply device 4 has a power switch 4a and a pedal switch 4b, and supplies power to the ultrasonic oscillator 6 in the handpiece 2 when the power switch 4a it turned on and the pedal switch 4b is pressed with the foot. And then, a drive signal is sent from the ultrasonic oscillator 6 to the ultrasonic vibrator 7, causing the ultrasonic vibrator 7 to vibrate ultrasonically.

Method for Making Space

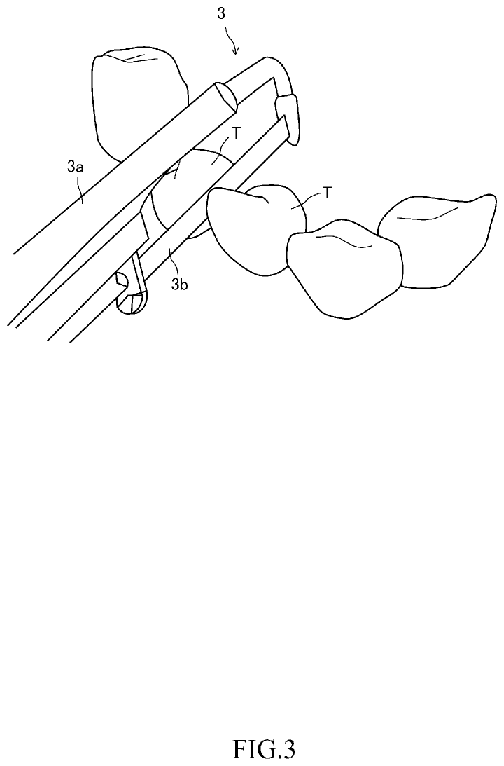

Next, the method for making space between teeth using the device for making space 1 as explained above will be described with reference to the FIG. 3 through FIG. 5.

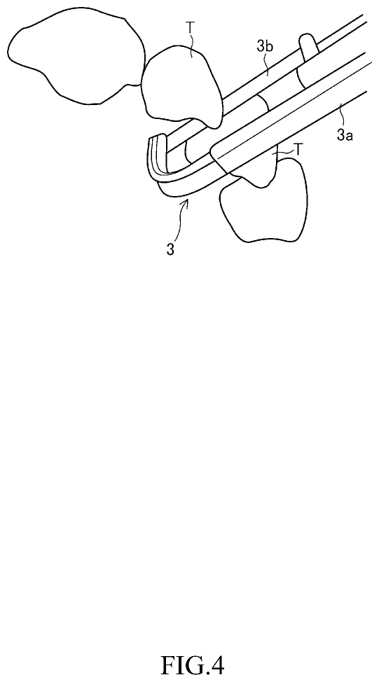

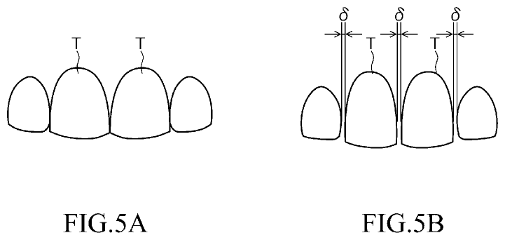

FIG. 3 is a partial perspective view illustrating the device for making space being used for space making in the lower interdental, FIG. 4 is a partial perspective view illustrating the device for making space being used for space making in the upper interdental, and FIG. 5A is a partial front view illustrating the dentition before space making and 5B is a partial front view illustrating the dentition after space making.

In space making, where a necessary space (gap) is formed between two adjacent teeth (dentition) T in orthodontic treatment, the opposing side of each of the two teeth are ground by the grinding tip 3. Specifically, since the thickness of the enamel of the tooth T is about 1 to 2 mm, it is ground within about ⅓ of its thickness (about 0.25 mm on each side). In this case, the tooth T will not get sensitive or decay as the enamel remains on the tooth T.

By the way, even if the two adjacent teeth are in contact with each other under normal conditions as shown in the FIG. 5A, the 0.07 mm thick file 3b of the grinding tip 3 can be inserted between both teeth T in many cases.

In the method in the present invention, a plurality of the grinding tip 3 with the files of different thickness are prepared in advance. Then, first of all, the grinding tip 3 with the thinnest file 3b with a thickness of 0.07 mm is attached on the holder 8 (see FIG. 2) of the handpiece 2. Next, the person who gives treatment grabs the handle 2A (see FIG. 1) of the handpiece 2 and inserts the 0.07 mm thick file 3b of the grinding tip 3 between the two adjacent teeth T on the lower side, as shown in FIG. 3, for example. When inserting the file 3b between two teeth T on the upper side, the file 3b is inserted between the two adjacent teeth T by reversing the top and bottom of the grinding tip 3 (so that the file 3b is on top), as shown in FIG. 4.

When the person who gives treatment steps a pedal switch 4b shown in FIG. 1 with the 0.07 mm thick file 3b inserted between the two adjacent teeth T as described above, power is supplied from the power supply device 4 to the ultrasonic oscillator 6 in the handpiece 2 and the drive signal is sent from the ultrasonic oscillator 6 to the ultrasonic vibrator 7. Then, the ultrasonic vibrator 7 vibrates ultrasonically preferably at a drive resonance frequency, and the ultrasonic vibration of the ultrasonic vibrator 7 propagates through the holder 8 to the grinding tip 3. So, the file 3b on the grinding tip 3 vibrates ultrasonically between the two adjacent teeth T and this ultrasonic vibration of the file 3b grinds the opposing surfaces of the two teeth T. As a result, a space (gap) which is slightly larger than 0.07 mm, the thickness of the file 3b, is formed between the two adjacent teeth T. In addition, at the same time as the grinding of the teeth T, water (a tap water, in this embodiment) is continuously supplied from the water pouring hose 5 to the grinding area of the teeth T by the file 3b, and this water promotes the discharge of grinding dust and the cooling and lubrication of the grinding area.

Here, the principle of grinding by ultrasonic vibration of the file 3b will be explained. When the file 3b vibrates ultrasonically, the grinding surfaces on both sides of the file 3b repeatedly contact and separate from the teeth T. In this way, the teeth T can be ground by the file 3b without moving the file 3b between the teeth T.

By the way, in this embodiment, a space (gap) of 0.5 mm eventually needs to be formed between the two adjacent teeth T. Therefore, in the holder 8 (see FIG. 2) of the handpiece 2, the grinding tips 3 with the files 3b of different thickness are sequentially replaced to grind the teeth T repeatedly in the same manner as described above. In this way, it is possible to form a space (gap) that gradually increases in size between the two teeth T. Specifically, for example, the grinding of the teeth T is repeated by sequentially replacing the file 3b of the grinding tip 3 whose thickness is 0.1 mm, 0.13 mm. 0.16 mm, 0.18 mm, 0.2 mm, 0.25 mm, 0.3 mm, 0.4 mm, and 0.5 mm.

As a result of the above, a space (gap) δ of the desired size (0.5 mm in the present embodiment) is efficiently formed in a short time as shown in FIG. 5B between the teeth T, which were lined up in an orderly manner in contact with each other before grinding, as shown in FIG. 5A. This method can dramatically reduce the time required for space making from 150-300 minutes in the past to 15-30 minutes, thus reducing the physical burden on the patient and the person who gives treatment.

The present invention is not limited to the above embodiment, and various modifications may be made within the scope of the technical ideas described in the claims, specification, and drawings.

1. A device for making space between teeth for forming a necessary space between teeth comprising at least:
an ultrasonic oscillator;
an ultrasonic vibrator which receives a driving signal from the ultrasonic oscillator and vibrates ultrasonically;
a grinding tip to which the vibration from the ultrasonic vibrator is transmitted; and
a power supply device which supplies power to the ultrasonic oscillator.

2. The device for making space between teeth according to claim 1,
wherein the grinding tip comprises a file consisting of hard particles adhered to the surface of a flat substrate.

3. The device for making space between teeth according to claim 1,
comprising a handpiece with a built-in holder connected to the ultrasonic vibrator, and
wherein the grinding tip is detachably attached on the holder, and
wherein a water pouring section is installed inside or outside of the handpiece to supply water toward the grinding tip.

4. A method for making space between teeth to form a necessary space between teeth using a device for making space comprising at least:
an ultrasonic oscillator;
an ultrasonic vibrator which receives a driving signal from the ultrasonic oscillator and vibrates ultrasonically;
a grinding tip to which the vibration from the ultrasonic vibrator is transmitted; and
a power supply device which supplies power to the ultrasonic oscillator,
wherein the grinding tip is inserted between the two adjacent teeth and is used to grind the opposing surfaces of the two teeth by its ultrasonic vibration.

5. The method for making space between teeth according to claim 4,
wherein the device for making space comprising a handpiece with a built-in holder connected to the ultrasonic vibrator,
wherein a plurality of the grinding tip with different thickness are prepared, and
wherein a thinner grinding tip is sequentially replaced with thicker grinding tips on the holder of the handpiece, and
wherein the process of grinding the opposing surfaces of the adjacent teeth by the grinding tip is repeated multiple times.

6. The method for making space between teeth according to claim 4,
wherein the teeth are ground while water is supplied to the grinding area of the teeth by the grinding tip.
